(19) United States
(12) Patent Application Publication
(10) Pub. No.: US 2004/0051323 A1
(43) Pub. Date: Mar. 18, 2004

(54) Position means for objects and more especially for pneumatic handling devices

(76) Inventors: Eberhard Stohr, Esslingen (DE); Peter Lobelenz, Urbach (DE)

Correspondence Address: Charles R Hoffmann, Hoffmann & Baron, 6900 Jericho Turnpike, Syosset, NY, 11791, US

(21) Appl. No.: 10/415,251

(22) PCT Filed: Jul. 30, 2002
(86) PCT No.: PCT/EP02/08458

(51) Int. Cl. B66C 1/02

(52) U.S. Cl. 294/65; 294/64.1

(57) ABSTRACT

A positioning means for objects and more particularly for pneumatic handling devices, has positioning means for positioning in at least one direction in space. The positioner means (33) engage a holding device (17, 30 and 34) for the object (10 and 11) to be positioned which by way of a pneumatic setting member arrangement (23) is connected with the holding device (17, 30 and 34), the direction of setting of the setting member arrangement (23) matching the or one of the directions of movement of the positioner means (33). The setting member arrangement (23) for precision positioning comprises at least one contracting member, which has a contracting hose (26) extending between two head pieces (24 and 25) and performing a longitudinal contraction on being subjected to an internal pressure.

The invention relates to a positioning means for objects and more particularly for pneumatic handling devices, comprising positioner means for positioning in at least one direction in space.

For instance in the manufacture of printed circuit boards the boards must be positioned for the various different operations, turned over and passed on to the next processing station. The positioning and movement of the printed circuit boards is in this case normally performed using a handling device, in the case of which a plurality of suction grippers is arranged in one plane. Furthermore other objects must be positioned in a similar manner during manufacture or assembly, frequently with the aid of pneumatic arrangements having setting members and/or carriages for positioning in three directions in space, pivoting and rotary movement being performed. In the case of positioning in one particular setting direction there is frequently the problem that on the one hand relatively large setting displacements of the order of decimeters are involved while on the other hand an accuracy of positioning of millimeters or tenths of a millimeter is required. State of the art designs necessitate a very substantial technical and financial investment.

One object of the present invention is to create a positioning means making possible highly precise positioning economically and even over large displacements.

In order to achieve this aim in accordance with the invention the positioner means engage a holding device for the object to be positioned which by way of a pneumatic setting member arrangement is connected with the holding device, the direction of movement of the setting member arrangement matches the or one of the directions of movement of the positioner means and furthermore the setting member arrangement comprises at least one contracting member for precision positioning, said contracting member comprising a contracting hose extending between two head pieces and adapted to perform longitudinal contraction on being subjected to internal pressure.

The design of a setting member arrangement comprising one or more contracting members, see for example the assignee's sales literature with the title “Fluidic Muscle”, the European patent publication 0 161 750 B1 or the German patent publication 29,990,626 U (utility model) offers the advantage that extremely precise positioning of the object to be positioned in the millimeter or tenths of a millimeter range is economically possible with relatively low costs. Simple design and a low wear rate can be named as further advantages. Approximate positioning may take place using conventional positioner means and precision positioning is implemented using the setting member arrangement having contracting members. More particularly sheet-like objects such as plates and boards can be exactly positioned without any danger of skew running. A plurality of contracting members, which are respectively subjected to the same internal pressure, perform the same longitudinal contraction or, respectively, extension so that for example in the case of boards to be positioned exact movement perpendicular to the plane of the boards may be performed.

The measure recited in the dependent claims represent advantageous further developments and improvements with respect to the positioning means of claim 1.

Particularly satisfactory precision positioning may be achieved with contracting members, on both of whose head pieces a strand structure, which is coaxial to the contracting hose, is secured, which possesses two strand groups, placed in a crossover array, in each strand group flexible strands with the same longitudinal alignment being arranged alongside each other. The degree of precision may be enhanced even more if the strand groups are spaced apart by intermediately placed material, for instance a rubber material or an elastomeric material.

The positioner means are preferably designed for positioning in three directions in space, it being possible for means to be additionally provided for pivoting and/or rotating in order to produce adaptable prepositioning. The positioning means are in this case preferably pneumatically operated, although however other designs are conceivable, as for example hydraulic or electrical designs.

A particularly precise positioning of the contracting member or members is to be attained by a proportional pressure regulating valve able to be set to a predetermined target value. Using an electrical target value preset module it is possible for any desired analog target values to be set, for instance by way of a potentiometer integrated respectively therein. Digital setting of the predetermined target value is naturally also possible as well.

It is more especially advantageous to employ such a positioning means for pneumatic handling devices and more particularly for the handling of boards and foils. In this case the pneumatic handling device may comprise a plurality of suction grippers arranged in one plane and/or of a suction plate consisting of porous material or sintered material and able to be subjected to a suction pressure dependent on whether thick or thin and more flexible boards or foils are to be handled. For positioning and handling such thin boards or foils under a thickness of for example 0.5 mm such a plate is utilized, which produces a constant, low suction pressure over its entire suction face so that such boards or foils engage such suction face pneumatically and are not thereby deformed. Thicker and stiffer boards may on the other hand not be moved using such suction plates, since owing to manufacturing inaccuracies such boards are not exactly flat and do not engage over the full surface. For such board suction gripper arrangements are utilized.

It is an advantage for the suction plate to be provided with openings permitting the passage therethrough of the suction grippers so that in a first positioning state of the setting member arrangement the suction grippers protrude past the suction face of the suction plate and in a second positioning state the suction grippers are retracted into the openings with the result that they do not project past the suction face of the suction plate. By simple operation of the contracting members it is possible to switch over between the two positioning conditions so that a change over between the handling of thicker and stiffer boards on the one hand and thinner and more flexible boards on the other hand can be achieved rapidly and without retooling under the control of a program.

It is convenient for control means to be provided for on the one hand acting on the suction plate and the suction grippers and on the other hand using suction pressure or vacuum, the suction grippers only being able to be subjected to suction pressure in the first positioning state. In this case it is possible to prevent any possibility of the suction grippers in the second positioning state, despite a certain distance from the thin foil or board to be handled, drawing the foil or board into the openings and possibly damaging it. In this first positioning state it is convenient for the suction pressure for the suction plate to be turned off in order to prevent unnecessary use of vacuum. Furthermore the suction pressure may be economized in, if in the case of small boards to be handled only those suction grippers or, respectively, only those portions of the suction plate are subjected to suction pressure, which essentially match the configuration of the board.

In accordance with an advantageous design the suction plate is connected in a sealing manner on its side opposite its suction face with a suction supply plate, which has at least one suction pressure supply connection, such suction supply connection being connected with at least one sheet-like plenum between the plates, which is constituted by a well in at least one of the plates. Having such sheet-like plenum or plenums means that a maximum surface of the suction plate is subjected to the vacuum, something which in turn means that the action of the vacuum at the suction face is as even as possible. The suction supply plate is in this case preferably provided with the openings, matching the suction board for the suction grippers.

One working example of the invention is represented in the drawings and will be described in detail in the following account.

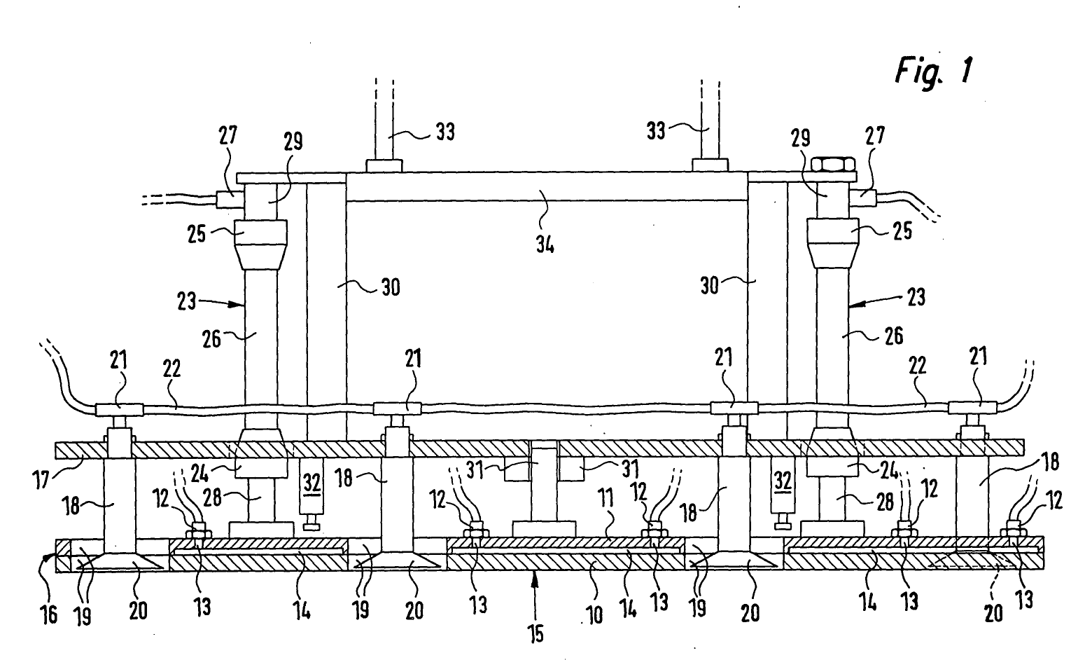

FIG. 1 is a representation in vertical section of a positioning means as a working example of the invention.

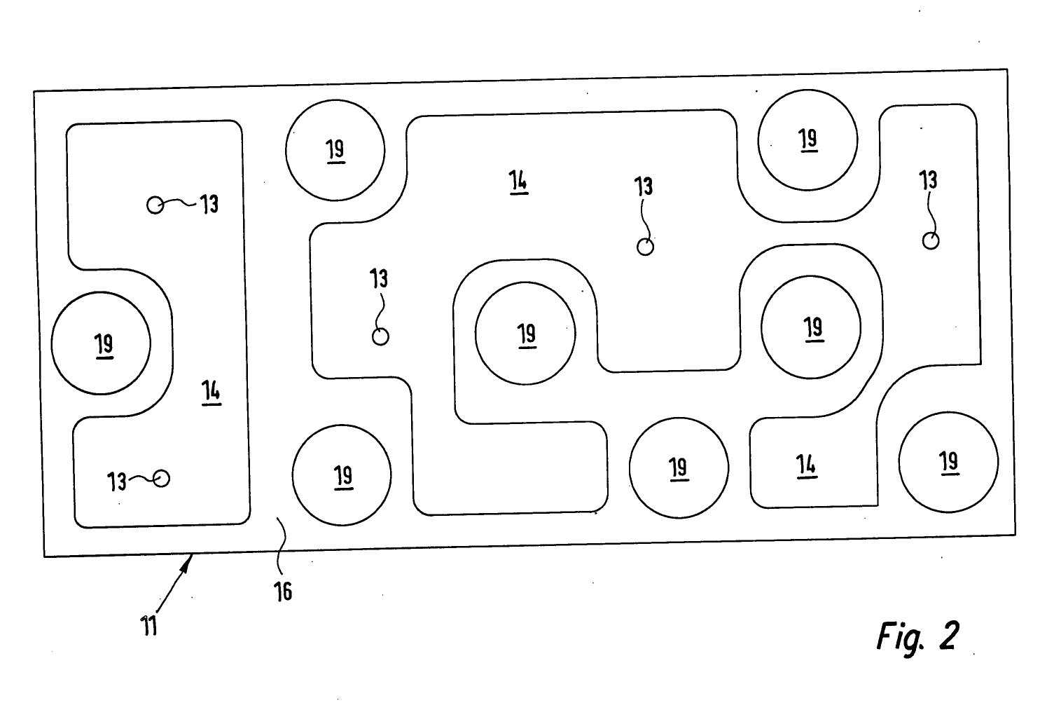

FIG. 2 is a view of the side, provided with the wells, of a suction supply plate, which is connected with a suction plate.

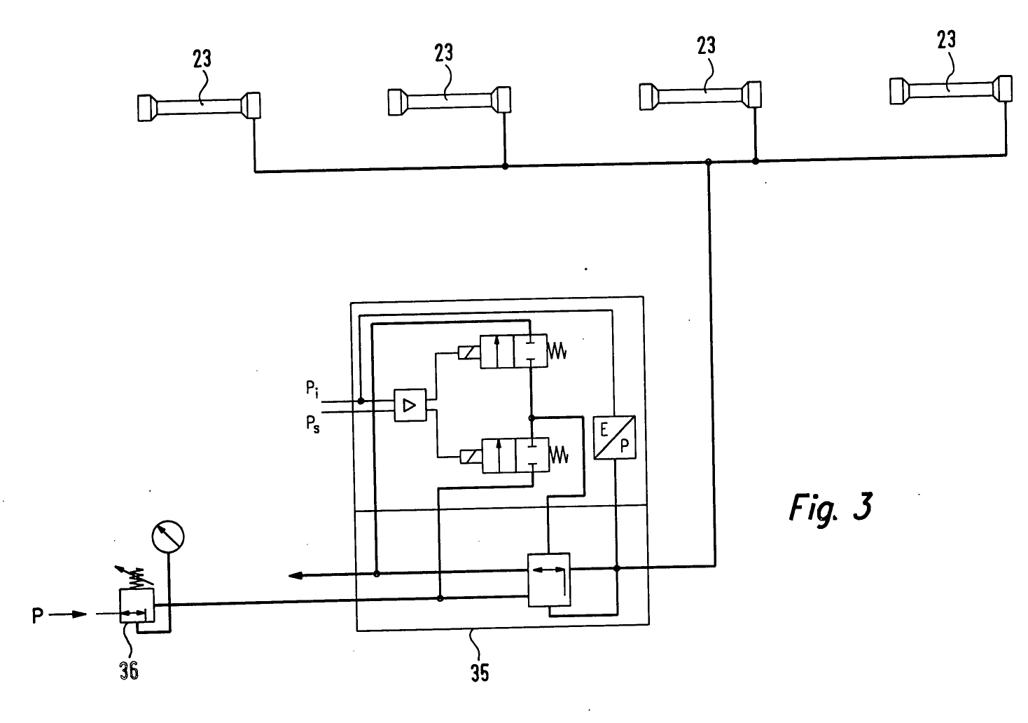

FIG. 3 shows a pressure regulating arrangement for the positioning means consisting of four contracting members.

The positioning means represented as a working example in FIG. 1 has as an object to be positioned, a suction plate 10 in the form of a composite board, such board being of a porous, air-permeable material or a sintered material, and a suction supply plate 11 connected with it. The suction plate 10 consists in this case for example of air-permeable aluminum as is commercially available under the name of Metaphor. Other metallic sintered plates can obviously be employed as well. Furthermore the suction supply plate 11 will for example consist of aluminum, an aluminum alloy or some other metal such as a light metal.

The side of the suction supply plate 11 facing away from the suction plate 10 is provided with pneumatic connections 12, which are connected by way of ducts 13 with shallow wells 14 on the opposite side of this suction supply plate 11. On connecting the two plates 10 and 11 such wells form shallow plenums, by way of which suction pressure applied to the connections 12 may act over a maximum area of the suction plate. Accordingly on the side, facing away from the suction supply plate 10, which constitutes the suction face 15 of the suction plate 10, a maximally even suction pressure for securing thin boards to be handled is produced. The contact faces 16, arranged to the side of the wells 14 and surrounding same, of the suction supply plate 13 are connected in a sealing manner with the suction plate 10, for example using suitable bonding or sealing materials.

As an alternative to this the wells 14 may in principle also be provided in the suction plate 10 or on both plates 10 and 11.

On a holding plate 17, which is arranged parallel to the plates 10 and 11, a plurality of suction grippers 18 is fixed, of which four are depicted in FIG. 1, three in the plane of the section and one behind such plane. These suction grippers 18 extend as far as positions in the openings 19, which extend through the suction plate 10 and the suction supply plate 11, in each case flush with each other. The suction elements 20, which are illustrated in the positioning state on the suction end of the suction grippers 19, are arranged within the openings 19, that is to say, they do not protrude beyond the suction face 15 of the suction plate 10.

The suction grippers 18 are connected by means of tee pieces with a suction pressure line 22, which serves for the simultaneous supply of suction pressure to the suction grippers 18. A corresponding arrangement is also necessary for the pneumatic connections 12 or is provided therefor, but is not illustrated in order to simplify the drawing.

The suction supply plate 11 and the holding plate 17 connected by way of four contracting members 23, which constitute a pneumatic setting member arrangement, with one another. The contracting members 23 each possess a contracting hose 26 extending between two head pieces 24 and 25, of rubber elastic material, which by way of a pneumatic connection 27 may be connected with a source of actuating fluid. The action of the pressure causes a radial expansion of the contracting hose 26, a strand structure, which is for example embedded, causing an axial contraction with the result that the two head pieces are pulled together. The resulting change in length of the contracting member 23 may be preset extremely exactly in accordance with the predetermined pressure of the actuating fluid.

For particularly precise positioning contracting members 23 with a strand structure fixed to the two head pieces and coaxial to the contracting hose 26 are suitable, such structure containing two strand groups arranged in a crossover configuration, each group having within it flexible strands extending alongside each other with the same longitudinal alignment. The strand groups are in this case spaced apart by intermediate yielding material, as for instance a rubber material or an elastomeric material. Owing to the absence of immediate contact between the strand groups the load on the strand material is substantially reduced and at the same time the efficiency is improved. Such contracting members are for example disclosed in the said German patent publication 29,990,626 U.

The bottom head pieces 24 of the contracting members 23 are in this case attached by way of attachment members 28 to the suction supply plate 11 and to the top head pieces 25 by way of attachment members 29 to L-like holding elements 30, said members 29 also being provided with pneumatic connections 27, said holding elements 30 extending like a gantry from the holding plate 17 upward. The contracting members 23 extend in this case through matching openings in the holding present 17. For guiding the movement of the holding plate 17 on the one hand and of the suction supply plate 11 combined with the suction plate 10 on the other hand toward each other and away from each other use is made of a guide element 31, it being possible to provide a plurality of guide elements 31 dependent on requirements and on the plate size. The same applies for the contracting members 23, of which in the working example there are four. This number as well may be changed dependent on the guide elements 31.

Abutment members 32 arranged on the holding plate 17 and extending toward the suction supply plate 11 limit the motion of the holding plate 17 toward the suction supply plate 11 that in the abutting position the suction elements 20 of the suction grippers 18 extend down so far past the suction face 15 that a board to be handled can be gripped by them.

Pneumatic or electrical positioner means 33, of which for purposes of simplification only the ends of actuating members, for example piston rods and actuating cylinders, are illustrated, serve to move and position the entire arrangement. These positioner means 32 engage a holding device 34, which in the working example is connected with the holder elements 30. They may for example also engage the holding plate 17 directly or a device connected with it. Owing to these positioner means 33 the entire arrangement may be for example positioned in three directions in space and be pivoted or turned if needed.

In the positioning state of FIG. 1 the suction elements 20 of the suction grippers 18 are drawn into the openings 19 so that the suction face 15 of the suction plate 10 represents the bottom plane. By the action of suction pressure at the pneumatic connections 12 a suction action over a sheet is produced by the suction plate 10, by which very thin boards, as for example printed circuit boards, or foils may be engaged for holding them without any damage in order to be able to handle them together with entire arrangement using the positioner means 33, as for example to position them or transfer them from one working station to the next one.

In order to be able to handle relatively thick or stiff boards the pneumatic connections 27 of the contracting members 23 are supplied with working pressure so that same contract until the suction supply plate 11 comes into contact with the abutment members 32. Now the suction elements 20 of the suction grippers 18 project downward past the suction face 15 of the suction plate 10 and owing to supply of suction pressure by way of the suction pressure line 22 such a board may be held on the suction elements 20 in order to be then positioned or moved on farther. The following deposit both of thick and also thin boards can then take place in the desired position by increasing pressure above atmospheric pressure.

The exact positioning of the contracting members 23 in accordance with FIG. 3 occurs using the action of pressure supplied by way of a proportional pressure regulating valve 35. It is placed downstream from a pressure regulator 36. Such a proportional pressure regulating valve 35 is for example commercially available as component MPPES-3-1/8-10-010 supplied by the assignee. Dependent on the desired set position of the contracting members 23 a target pressure Ps is set, for example using an electrical target value module as is commercially available under the designation MPZ-1-24DC SGH-6SW. In this case there is a possibility of setting six analog target values each using an integrated potentiometer and then retrieving them by way of an associated digital input. Regulation takes place by a comparison with the true pressure value Pi at the output of the proportional pressure regulating valve 35. Using such an arrangement it is possible to exactly set positions with an accuracy of 1/10 mm, no position sensors being necessary on the contracting members 23.

The contracting members 23 are furthermore suitable, independently of the positioning of the suction grippers 28, for precision positioning of the suction plate 10 and, respectively, of the suction supply plate 11. For this purpose the contracting members 23 must be in an at least partially contracted condition whereas coarse positioning takes place using the positioner means 33. This coarse positioning takes place with an accuracy of 1/10 mm right over the thin board or foil to be gripped. By reducing the pressure in the contracting members 23 precise lowering of the suction plate 10 and positioning as far as the board or foil to be handled then occurs. For this purpose the contracting members 23 may further be provided with a spring arrangement which on a reduction in pressure enhances or aids in elongation of the contracting members 23.

This arrangement is naturally not only to be employed in conjunction with gripper means but on all occasions in which a board or some other object is to be accurately positioned by firstly roughly and then accurately positioning it.

1. A positioning means for objects and more particularly for pneumatic handling devices, comprising positioner means for positioning in at least one direction in space, characterized in that the positioner means (33) engage a holding device (17, 30 and 34) for the object (10 and 11) to be positioned which by way of a pneumatic setting member arrangement (23) is connected with the holding device (17, 30 and 34), the direction of movement of the setting member arrangement (23) matches the or one of the directions of movement of the positioner means (33) and furthermore the setting member arrangement (23) comprises at least one contracting member for precision positioning, said member comprising a contracting hose (26) extending between two head pieces (24 and 25) and adapted to perform longitudinal contraction on being subjected to internal pressure.

2. The positioning means as set forth in claim 1, characterized in that the at least one contracting member of the setting member arrangement (23) possesses a strand structure which is coaxial to the contracting hose (26) and is fixed to the two head pieces (24 and 25), which strand structure contains two strand groups with a crossover configuration and having flexible strands extending within each strand group with the same longitudinal alignment alongside one another.

3. The positioning means as set forth in claim 2, characterized in that the strand groups are held constantly spaced apart by an intermediately placed yielding material, such material preferably including rubber material or elastomeric material.

4. The positioning means as set forth in any one of the preceding claims, characterized in that the positioner means (33) are designed to position in three directions in space.

5. The positioning means as set forth in any one of the preceding claims, characterized in that the positioner means (33) are designed to pivot and/or rotate.

6. The positioning means as set forth in any one of the preceding claims, characterized in that the positioner means (33) are adapted to be operated pneumatically.

7. The positioning means as set forth in claim 6, characterized in that for positioning of the setting member arrangement (23) a proportional pressure regulating valve (35) is provided connected with it and setting the internal pressure of the contracting members in accordance with a predetermined target value (Ps).

8. The positioning means as set forth in any one of the preceding claims, characterized in that the object (10 and 11) to be positioned is in the form of a pneumatic handling device more particularly for handling boards and foils.

9. The positioning means as set forth in claim 8, characterized in that the pneumatic handling device comprises a plurality of suction grippers (18) arranged in a plane and/or a suction plate (10) consisting of porous material or sintered material and able to be subjected to suction.

10. The positioning means as set forth in claim 9, characterized in that the suction plate (10) is provided with openings (19) permitting the extension therethrough of the suction grippers and in that in a first positioning state of the setting member arrangement (23) the suction grippers (18) protrude past the suction face (15) of the suction plate (10) and in a second positioning state the suction grippers (18) are set back into the openings (19) with the result that they no longer protrude past the suction face of the suction plate.

11. The positioning means as set forth in claim 10, characterized in that control means are provided for causing suction pressure to act on the suction plate (10) on the one hand and the suction grippers (18) on the other hand, the suction grippers only being acted on by suction pressure in the first positioning state.

12. The positioning means as set forth in claim 10 or in claim 11, characterized in that the suction plate (10) is connected in a sealing manner on its side facing away from the suction face (15) with a suction supply plate (11), which is connected with at least one shallow suction cavity (14) between the plates (10 and 11) which is constituted by a well in at least one of the plates (11).

13. The positioning means as set forth in claim 12, characterized in that the suction supply plate (11) is provided with openings (19) matching the suction pressure plate (10), for the suction grippers (18).

14. The positioning means as set forth in any one of the preceding claims, characterized in that an abutment device (32) for limiting the movement toward each other of the plates (10 and 11) toward the first positioning state and/or a guide means (31) guiding the movement of the holding device in relation to the suction plate (10) is provided.
